(19) United States
(12) Patent Application Publication
(10) Pub. No.: US 2011/0289046 A1
(43) Pub. Date: Nov. 24, 2011

(54) Systems and Methods for Archiving Business Objects

(76) Inventors: R. Wey Leach, Greenville, SC (US); Jerry M. Overton, Wake Forest, NC (US); William M. Shook, Cary, NC (US); Balthazar J. Valez, Wake Forest, NC (US); George B. Wall, High Point, NC (US); Daniel S. Milburn, Cary, NC (US)

(21) Appl. No.: 12/896,211

(22) Filed: Oct. 1, 2010

Related U.S. Application Data
(60) Provisional application No. 61/247,785, filed on Oct. 1, 2009.

(51) Int. Cl. G06F 17/30

(52) U.S. Cl. 707/602; 707/668; 707/662; 707/E17.005; 707/E17.01; 707/E17.044

(57) ABSTRACT

The invention relates to systems and methods for archiving business objects, particularly unstructured information from email and journaling agents and file systems. The systems and methods include a remotely installed archiving agent on a target server connected via VPN to a source system at a client location. The target servers are located at a remote Tier IV, SAS70 certified data center that is staffed by operators monitoring the archive process. The systems and methods include the movement of data from individual target servers to individual SQL servers to a data warehouse which provides support for a web portal. This web portal allows for enhanced search capabilities across different file types of archived business objects.

### CROSS-REFERENCE TO RELATED APPLICATIONS

This application claims the benefit of U.S. Patent Application No. 61/247,785, filed Oct. 1, 2009, which is incorporated herein by reference.

### BACKGROUND

1. Field of the Invention

The invention relates to systems and methods for archiving business objects. More particularly, the invention relates to systems and methods for archiving business objects, such as categorized data, for storage maximization and to meet compliance requirements.

2. General Background

Archiving of business objects is an important element in data management for any business. Using archiving tools, a business can automate data storage and retention, decrease the needed capacity for data storage, improve overall system performance, and more easily comply with legal discovery of data information.

Without an archiving solution, business typically store information on multiple media, from USB flash drives to hard drives and server clusters. The problem with this type of storage is that it is usually bound to one physical location or computer. In the event of a physical disaster or other catastrophic loss of data, the archived data also may be lost. Thus, it is preferable to archive data onto a consolidated, efficient data infrastructure at a remote location.

Many data archiving solutions are known; however, these know solutions do not meet the needs of businesses. For example, there is a multitude of archiving software available to consumers. This software must be installed on a local server or computer by the consumer or someone hired by the consumer. Depending on the software requirements and the system configuration, it may require purchasing and installing additional servers and/or storage devices. This places an additional cost and knowledge burden on the consumer who must also maintain the software with updates and new versions. In addition to the capital outlay for the software and/or additional hardware, there may be long lead times, systems optimization requirements, and user training related to the use of archiving software.

Archival solutions available through cloud computing eliminate some of the burdens associated with local archiving, but generally still require the local installation of the archiving agent. For example, other data archiving systems provide a full hardware configuration of an archiving agent environment, which is hosted in a remote data center. This solution merely relocates the physical location of hardware (servers, switches, storage), but maintains many of the limitations of a local system. Thus, an archiving solution is needed that overcomes these limitations.

### BRIEF SUMMARY OF THE INVENTION

Embodiments of the invention provide a system for archiving business objects including at least one source system located on a remote network; two or more target servers located at a data center; at least one virtual private network device to transmit business objects from the source system to the target server; an archiving agent located on the target servers; a data center; and an internet-based portal for accessing the archived data.

Embodiments of the invention include a system for archiving business objects from messaging, file servers and collaborative systems including at least one source system located on a remote network; two or more target servers located at a data center, wherein the target servers are partitioned into multiple virtual servers and each virtual server is assigned to an individual set of business objects associated with one source system; at least one virtual private network device to transmit copies of business objects and meta data related to the business objects from the source system to the target server; an archiving agent located on the target servers; a Tier IV, SAS70 certified data center; and an internet-based portal for accessing the archived data, wherein the portal allows a user to search the archived data.

In some embodiments, the invention includes a method for archiving business objects on a remote network including joining at least one remote source system via a virtual private network device to at least two target servers including an archiving agent; identifying parameters for selection of business objects on the at least one remote source system to be archived; archiving selected business objects by storing a copy of the business objects on the target servers; and gathering and storing meta data associated with the business objects to be stored.

In still other embodiments, the method further includes collecting audit data created by the archiving agent into SQL tables; storing the collected audit data in a data warehouse; and using the stored audit data to provide snapshots of an individual environment on the target servers.

In other embodiments of the invention, the method further includes using the stored audit data to comply with discovery requests or document retention policies.

In embodiments of the invention, the method further includes deleting the originally selected business objects; and replacing the originally selected business object with a shortcut to access the stored copy of the business object on the target server.

In certain embodiments of the invention, the archiving agent is Symantec Enterprise Vault.

In other embodiments of the invention, the data center is a Tier IV, SAS70 certified data center.

In certain embodiments of the invention, the business objects are information from messaging, file servers and collaborative systems.

In other embodiments of the invention, the business objects include unstructured information from Microsoft Exchange email and journaling, Microsoft SharePoint or File Systems.

In some embodiments of the invention, meta data related to the business objects is transmitted with the business objects to the target servers.

In certain embodiments of the invention, the target servers are partitioned into multiple virtual servers and each virtual server is assigned to an individual set of business objects associated with one source system.

Further details and embodiments of the invention are set forth below. These and other features, aspects and advantages of the invention are better understood when the following Detailed Description is read with reference to the accompanying drawings.

### BRIEF DESCRIPTION OF THE DRAWINGS

FIG. 1 is a block diagram of a system according to embodiments of the invention.

FIG. 2 is a block diagram of a demonstrating the flow of data in systems according to embodiments of the invention.

FIG. 3 is a screen capture of a web portal accessible in systems according to embodiments of the invention.

FIG. 4 is a flow chart of a method of archiving data according to embodiments of the invention.

### DETAILED DESCRIPTION OF THE INVENTION

This invention will now be described more fully with reference to the drawings, showing preferred embodiments of the invention. However, this invention can be embodied in many different forms and should not be construed as limited to the embodiments set forth.

The invention generally relates to systems and methods for archiving business objects. Business objects are a broad category of business processes that are modeled as objects. A business object can be as large as an entire order processing system or a small process within an information system. Business objects are objects in an object-oriented computer program that represent the entities in the business domain that the program is designed to support. For example, an order entry program might have business objects to represent each order, line items, and invoices. In preferred embodiments of the invention, the business objects include information from messaging, file servers and collaborative systems. In other embodiments of the inventions, the business objects include unstructured information from multiple sources, such as Microsoft Exchange Email and Journaling, Microsoft SharePoint, and File Systems.

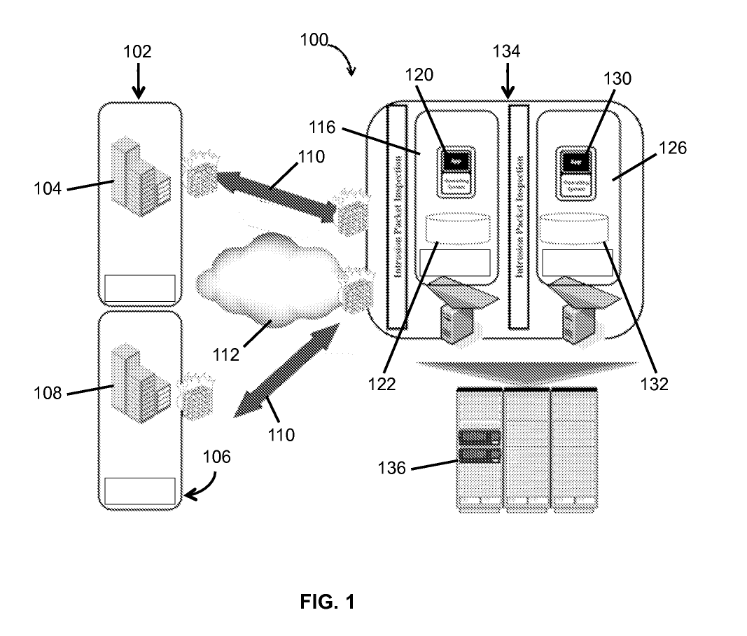

As shown in FIG. 1, according to embodiments of the invention, the system 100 for archiving business objects includes the secure movement of business objects from a source system to a target server. However, unlike other archiving systems, no agent or software is installed in the customer's environment 102, 106. Instead, as shown in FIG. 1, the archiving agent is located in a customer-dedicated environment 114, 124 on the target server 134. Thus, unlike a traditional archiving agent, the archiving agent is not locally installed, maintained or monitored. The archiving agent installed in the customer-dedicated environment 114, 124 is similar to a locally installed agent in its customization. Customers define the business objects and parameters by which the archiving agent identifies and archives data. The target server 134 is virtualized to create separate customer-dedicated environments 114, 124. Within these environments are customer-dedicated target servers 120, 130, including vlans 116, 126 and vaults 122, 132.

The customer-dedicated environments 114, 124 on the target server 134 are remotely connected to the actual customer environments 102, 106 in which the source systems 104, 108 are located. Business objects meeting the customer-identified parameters are exchanged via IPSEC VPN. As is known to those in the field, a virtual private network (VPN) is a network that is constructed by using public wires to connect nodes. These systems use encryption and other security mechanisms to ensure that only authorized users can access the network and that the data cannot be intercepted. In preferred embodiments, the VPN device 110 is a Juniper VPN device.

At the target server 134, the unstructured information of the business objects may be categorized and/or indexed to simplify retrieving the business objects at a later date, if necessary. For example, typical meta data such as “to,” “from,” and/or “date,” may be stored for an email. Typical meta data such as “owner,” “last accessed,” and/or “creator,” may be stored for files. Additionally, all files may be subjected to a full text index build that can be used to further classify the business objects that are stored.

The original business objects on the source system 104, 108 in the customer's environment 102, 106 may be retained or deleted. In some embodiments, the business objects are deleted and replaced with a shortcut or stub for access to the copy of the business object on the vlan 116, 126. The business objects are stored in a “vault.” The vault refers broadly to the location of the audit data from the archiving agent.

In preferred embodiments, the customer-dedicated servers 120, 130 may be created using hypervisor architectures, such as VMware ESX, meaning they install directly on top of the physical server and partition it into multiple virtual machines that can run simultaneously, sharing the physical resources of the underlying server. Each virtual machine represents a complete system, with processors, memory, networking, storage and BIOS, and can run an unmodified operating system and applications.

The target server 134 stores the archived business objects in customer assigned volumes at a remote data center 136. Preferably, the remote data center 136 is a Tier IV, SAS70 certified data center. The remote data center 136 is staffed by operators who configure and monitor the archiving system.

In use, customers may need to access the business objects that have been archived. In the case of emails and journaling, customers often need to refer to older business objects. In the event of litigation or compliance requirements, customers may need to access the business objects in an organized, searchable manner. Thus, the archiving system according to embodiments of the invention includes provisions to make the archived information easily accessible and easily searchable. Via an internet cloud 112, systems according to embodiments of the invention include a web portal that provides customers access to the archived business objects. This web portal also provides search capabilities that allow customers to search across all the archived file types to achieved targeted and detailed search results.

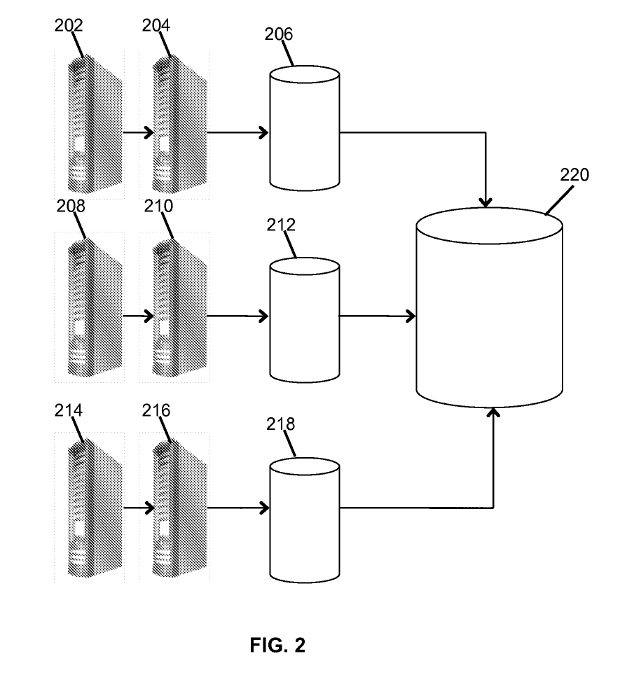

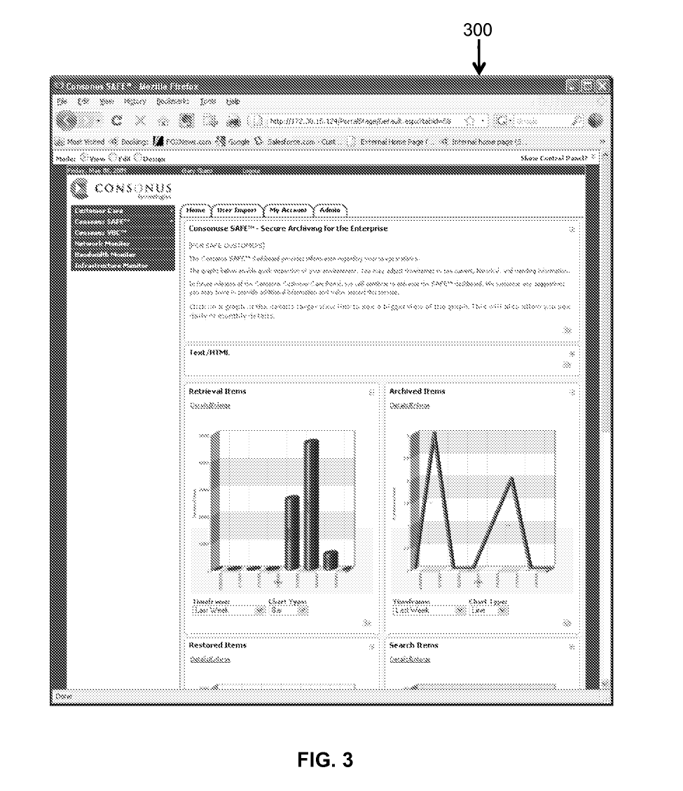

FIG. 2 illustrates the flow of data from individual customer target servers 202, 208, 214 into the remote data center 220. As shown in FIG. 2, data flows from the individual target servers 202, 208, 214 to individual SQL servers 204, 210, 216. From there, it moves to individual SQL databases 206, 212, 218. These SQL databases are housed in a data warehouse 220 and provide support for the web portal. Thus, FIG. 2 illustrates how individual customer archive systems, including SQL databases of audit data, feed to the data warehouse for use by the web portal 300 (shown in FIG. 3).

The web portal 300 accessible via internet cloud 112 (shown in FIG. 1) is shown in FIG. 3. The web portal 300 provides users with seamless integration into the archive system within the customer's environment. The web portal 300 provides a single point of search for the archived business objects. Thus, a search performed on the web portal 300 is enhanced by allowing the user to search multiple file types. Additionally, the data flow shown in FIG. 2 provides for single instance storage of data providing for even more accurate search results.

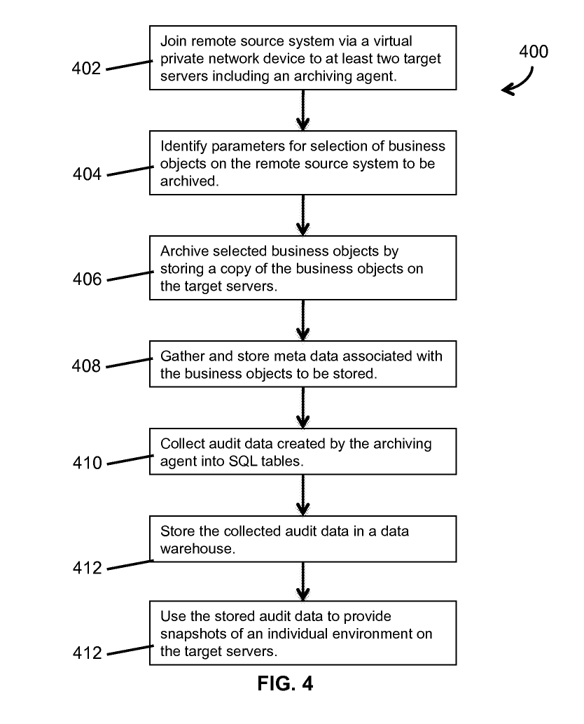

Embodiments of the invention include a method 400 of archiving data according to embodiments of the invention, as shown in FIG. 4. At step 402, a customer's remote source system is joined to at least two target servers via a private network device. The at least two target servers include an archiving agent for archiving business objects on the customer's source system. In preferred embodiments of the invention, the target servers are located at a remote data center. Preferably, the remote data center is a Tier IV, SAS70 certified data center. The remote data center is staffed by operators who configure and monitor the archiving system.

At step 404, operators at the remote data center identify parameters for the selection of the business objects on the remote source system to be archived. In some embodiments of the invention, the business objects include information from messaging, file servers and collaborative systems. In other embodiments of the inventions, the business objects include unstructured information from multiple sources, such as Microsoft Exchange Email and Journaling, Microsoft SharePoint, and File Systems.

At step 406, the selected business objects are archived by storing a copy of the business objects on the target servers. The archive is effected by using an archiving agent. In preferred embodiments of the invention, the archiving agent is Symantec's Enterprise Vault.

At step 408, meta data associated with the business objects is gathered and stored. The meta data gathered may be typical meta data such as “to,” “from,” and/or “date,” may be stored for an email. Typical meta data such as “owner,” “last accessed,” and/or “creator,” may be stored for files. Additionally, all files may be subjected to a fill text index build that can be used to further classify the business objects that are stored.

At step 410, audit data created by the archiving agent is collected into SQL tables. At step 412, the collected audit data is stored in a data warehouse, and at step 414, the stored audit data may be used to provide snapshots of an individual environment on the target servers.

In some embodiments of the invention, the method is complete when the business objects have been archived and the meta data has been stored. In other embodiments of the invention, the originally selected business objects are deleted from the source system in the customer's environment. If the originally selected business objects have been deleted, the original business objects are replaced with a shortcut to access the stored copy of the business object on the target server.

The foregoing description is provided for describing various embodiments and structures relating to the invention. Various modifications, additions and deletions may be made to these embodiments and/or structures without departing from the scope and spirit of the invention.

What is claimed is:

1. A system for archiving business objects comprising:
(a) at least one source system located on a remote network;
(b) two or more target servers located at a data center;
(c) at least one virtual private network device to transmit business objects from the source system to the target server;
(d) an archiving agent located on the target servers;
(e) a data center; and
(f) an internet-based portal for accessing the archived data.

2. The system of claim 1 wherein the archiving agent is Symantec Enterprise Vault.

3. The system of claim 1 wherein the data center is a Tier IV, SAS70 certified data center.

4. The system of claim 1 wherein the business objects are information from messaging, file servers and collaborative systems.

5. The system of claim 4 wherein the business objects include unstructured information from Microsoft Exchange email and journaling, Microsoft SharePoint or File Systems.

6. The system of claim 1 wherein meta data related to the business objects is transmitted with the business objects to the target servers.

7. The system of claim 1 wherein the target servers are partitioned into multiple virtual servers and each virtual server is assigned to an individual set of business objects associated with one source system.

8. The system of claim 1 wherein the business objects are copied from the source system to the target servers.

9. The system of claim 8 wherein the originally selected business objects are deleted and are replaced with shortcuts to access the stored copies of business object on the target servers.

10. A system for archiving business objects from messaging, file servers and collaborative systems comprising:
(a) at least one source system located on a remote network;
(b) two or more target servers located at a data center, wherein the target servers are partitioned into multiple virtual servers and each virtual server is assigned to an individual set of business objects associated with one source system;
(c) at least one virtual private network device to transmit copies of business objects and meta data related to the business objects from the source system to the target server;
(d) an archiving agent located on the target servers;
(e) a Tier IV, SAS70 certified data center; and
(f) an internet-based portal for accessing the archived data, wherein the portal allows a user to search the archived data.

11. The system of claim 10 wherein the archiving agent is Symantec Enterprise Vault.

12. The system of claim 10 wherein the originally selected business objects are deleted and are replaced with shortcuts to access the stored copies of business object on the target servers.

13. A method for archiving business objects on a remote network comprising:
(a) Joining at least one remote source system via a virtual private network device to at least two target servers including an archiving agent;
(b) Identifying parameters for selection of business objects on the at least one remote source system to be archived;
(c) Archiving selected business objects by storing a copy of the business objects on the target servers; and
(d) Gathering and storing meta data associated with the business objects to be stored.

14. The method of claim 13, further comprising:
(e) Deleting the originally selected business objects; and
(f) Replacing the originally selected business object with a shortcut to access the stored copy of the business object on the target server.

15. The method of claim 13 wherein the target servers are located at a remote data center.

16. The method of claim 15 wherein the remote data center is a Tier IV, SAS70 certified data center.

17. The method of claim 13 wherein the target servers are partitioned into multiple virtual servers and each virtual server is assigned to an individual set of business of objects associated with one remote source system.

18. The method of claim 13 further comprising:
(e) collecting audit data created by the archiving agent into SQL tables;
(f) storing the collected audit data in a data warehouse; and
(g) using the stored audit data to provide snapshots of an individual environment on the target servers.

19. The method of a claim 18 further comprising:
(h) using the stored audit data to comply with discovery requests or document retention policies.
